(19) United States
(12) Patent Application Publication
(10) Pub. No.: US 2023/0386121 A1
(43) Pub. Date: Nov. 30, 2023

(54) RENDER STREAMING AN ENVIRONMENT TO A PLURALITY OF USER DEVICES

(71) Applicant: ADLOID TECHNOLOGIES PRIVATE LIMITED, New Delhi (IN)

(72) Inventors: Kanav SINGLA, Punjab (IN); Karthik KANAUJIA, Haryana (IN); Shorya MAHAJAN, Haryana (IN); Rohit RANJAN, Haryana (IN); Ashish DASARI, Haryana (IN)

(21) Appl. No.: 18/322,974

(22) Filed: May 24, 2023

(30) Foreign Application Priority Data
May 24, 2022 (IN) 202211029821

(51) Int. Cl. G06T 15/00; H04L 65/61; G06T 15/04

(52) U.S. Cl. CPC G06T 15/005; H04L 65/61; G06T 15/04; G06T 2200/16

(57) ABSTRACT

The present subject matter discloses a server, a method, and a system for render streaming an environment to a plurality of user devices. According to aspects of the present subject matter, a single server may be configured to support concurrent streaming to multiple user devices in a manner such that each user device may get a personalized experience. In other words, the changes done to the environment by one user does not affect the user experience of the other users who are availing the render streaming services concurrently. As a result, the single server is able to host multiple users and provide a true personalized experience to all the users.

### FIELD OF THE INVENTION

The present subject matter relates to render streaming of an environment to user devices and, more particularly, to an apparatus, a method, and a system for render streaming of an environment to a plurality of user devices.

### BACKGROUND OF THE INVENTION

Render streaming may be understood as a technique in which resource intensive rendering operations pertaining to applications or games are shifted from the user's device to remote servers. That is, the resource intensive rendering operations are performed on the remote servers' side. The resulting output, for example, visuals, are then streamed back to the user's device via a network connection, such as the Internet. This enables real-time interaction with the application, eliminating the need for powerful hardware on the user's end.

Conventionally, a separate machine on the remote server side is installed and assigned for each render streaming request that is received from user devices. Thus, such conventional solutions are expensive to deploy and require heavy server configurations. Further, the conventional solutions also experience latency issues.

In another conventional technique, a single server may be assigned to multiple users for render streaming and a shared experience is provided to multiple users concurrently. However, the user experience of the multiple users may be degraded in such a shared experience setup. For instance, in the shared experience setup, the changes to the characteristics of the scene done by one user are rendered to the other users as well, which may be undesirable. As a result, the users' experience of the environment is degraded. Reference may be made to US2020294312A1 which enclosed a system and method for facilitating shared rendering between a multiple number of display devices. Another reference may be made to US2020294312A1 which enclosed a system comprising of a server, a memory and a virtual world.

### SUMMARY OF THE INVENTION

The present subject matter discloses a server, a method, and a system for render streaming an environment to a plurality of user devices. According to aspects of the present subject matter, a single server may be configured to support concurrent streaming to multiple user devices in a manner such that each user device may get a personalized experience. In other words, the changes done to the environment by one user does not affect the user experience of the other users who are availing the render streaming services concurrently. As a result, the single server is able to host multiple users and provide a true personalized experience to all the users.

According to an embodiment, a server for render streaming the environment to a plurality of user devices is disclosed. The server comprises a processor, a connection unit, a generating unit, a layering unit, a rendering unit, and a streaming unit. The connection unit may be coupled to the processor and may be configured to establish an active connection with each of the plurality of user devices in response to receiving a corresponding connection establishment request from the plurality of user devices. The generating unit may be coupled to the processor and may be configured to obtain a 3D scene corresponding to the environment. The generating unit may be further configured to generate a plurality of draw calls for a plurality of instances in the 3D scene. The layering unit may be coupled to the processor and may be configured to generate a plurality of unique layers corresponding to the plurality of user devices upon establishment of the active connections, obtain the plurality of generated draw calls corresponding to the 3D scene and filter the plurality of generated draw calls based on the plurality of unique layers to obtain a plurality of unique draw call sets corresponding to the plurality of user devices. The rendering unit may be coupled to the processor and may be configured to generate a set of render textures corresponding to the each of the plurality of user devices based on the unique draw call sets associated with the respective user devices. The streaming unit may be coupled to the processor and may be configured to stream the corresponding set of rendered textures to the respective user devices.

According to an embodiment, a method for render streaming an environment to a plurality of user devices is disclosed. The method comprises establishing an active connection with each of the plurality of user devices in response to receiving a corresponding connection establishment request from the plurality of user devices. The method further comprises obtaining a 3D scene corresponding to the environment and generating a plurality of draw calls for a plurality of instances in the 3D scene. The method further comprises generating a plurality of unique layers corresponding to the plurality of user devices upon establishment of the active connections. The method further comprises obtaining the plurality of generated draw calls corresponding to the 3D scene and filtering the plurality of generated draw calls based on the plurality of unique layers to obtain a plurality of unique draw call sets corresponding to the plurality of user devices. The method further comprises generating a set of render textures corresponding to each of the plurality of user devices based on the unique draw call sets associated with the respective user devices. The method further comprises streaming the corresponding set of rendered textures to the respective user devices.

Embodiments of the present subject matter facilitate in providing a personalized user experience of an environment which is being simultaneously render streamed to multiple users. As a result, changes in a scene of the environment effected by one user are not displayed to other users. This facilitates in both, maintaining the user experience for all the users and also maintaining the privacy of the user sessions. Furthermore, aspects of the present subject matter also facilitate supporting render streaming to multiple user devices using a single server. Thus, operation and maintenance costs related to implementation are also reduced.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates an example network environment, according to one or more embodiments of the present subject matter;

FIG. 2 illustrates a schematic block diagram of a server, according to one or more embodiments of the present subject matter;

FIG. 3 illustrates an operational flow diagram of the layering unit for render streaming an environment to a plurality of user devices, according to one or more embodiments of the present subject matter;

FIG. 4 illustrates an operational flow diagram indicating handling of update request by the server for render streaming an environment to a plurality of user devices, according to one or more embodiments of the present subject matter;

FIG. 5 illustrates a block diagram of the server indicating flow of operations performed for render streaming an environment to a plurality of user devices for the various user device types, according to one or more embodiments of the present subject matter;

FIG. 6 illustrates a block diagram depicting various channels established between the server and each of the plurality of user devices for render streaming, according to one or more embodiments of the present subject matter; and

FIG. 7 illustrates a flowchart of a method for render streaming an environment to a plurality of user devices, according to one or more embodiments of the present subject matter.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF INVENTION

It will be understood by those skilled in the art that the foregoing general description and the following detailed description are exemplary and explanatory of the disclosure and are not intended to be restrictive thereof. Throughout the patent specification, a convention employed is that in the appended drawings, like numerals denote like components.

Reference throughout this specification to “an embodiment”, “another embodiment”, “an implementation”, “another implementation” or similar language means that a particular feature, structure, or characteristic described in connection with the embodiment is included in at least one embodiment of the present disclosure. Thus, appearances of the phrase “in an embodiment”, “in another embodiment”, “in one implementation”, “in another implementation”, and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures proceeded by “comprises. a” does not, without more constraints, preclude the existence of other devices or other sub-systems or other elements or other structures or additional devices or additional sub-systems or additional elements or additional structures. Further, the terms “a” and “an” herein do not denote a limitation of quantity, but rather denote the presence of at least one of the referenced items.

Unless otherwise defined, all technical and scientific terms used herein have the same meaning as commonly understood by one of ordinary skill in the art to which this disclosure belongs. The apparatus, system, and examples provided herein are illustrative only and not intended to be limiting.

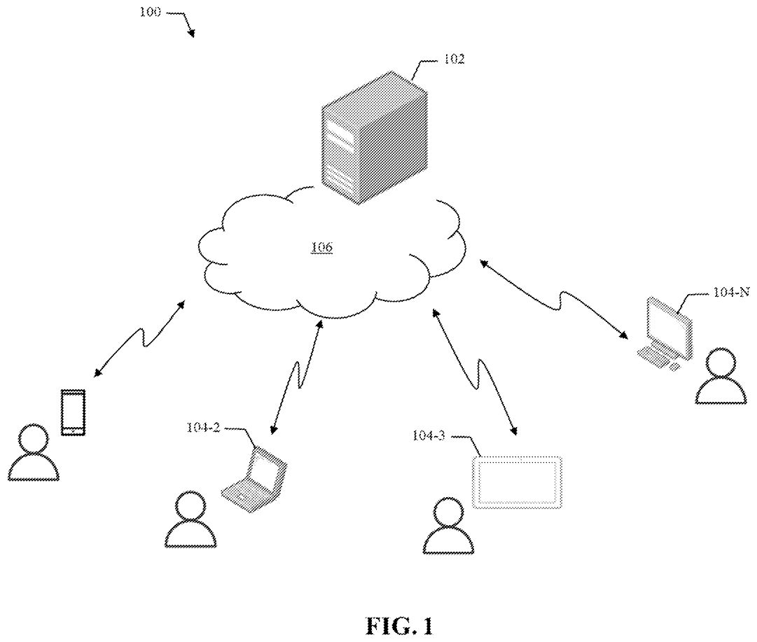

FIG. 1 illustrates an example network environment 100 implementing a server 102 for render streaming an environment to a plurality of user devices 104-1 to 104-N, according to one or more embodiments of the present subject matter. Examples of the server 102 may include a content server, a server-grade machine, a gaming server, etc. The server 102 may be implemented, for example, by an enterprise offering render streaming services to the user devices 104.

Examples of the environment may include, but are not limited to a Virtual Reality (VR) environment, an Augmented Reality (AR) environment, a Mixed Reality (MR) environment, and a 3D environment. Examples of Virtual Reality (VR) environment may include, but are not limited to VR games, Configurators, Virtual showrooms, VR training simulators, VR education, VR cinematic experiences, VR content viewers and editors. Examples of AR environment may include, but are not limited AR content viewers and editors, AR gaming, AR navigation and wayfinding, etc. Examples of MR environment may include, but are not limited to simulated training environments, spatial computing, etc.

Examples of the user devices 104-1 to 104-N may include a laptop, a smartphone, a desktop, a Virtual Reality (VR) device, a device supporting Augmented Reality (AR), and a device supporting Mixed Reality (MR), and the like. In FIG. 1, by way of example, a first user device 104-1 is depicted as smartphone, a second user device 104-2 is depicted as laptop, a third user device 104-3 is depicted as tablet supporting AR and Nth user device 104-N is depicted as a computer.

In an example, the user devices 104-1 to 104-N may connect with the server 102 to avail the render streaming services, using a network 106. The network 106 may be any of a wired network, a wireless network, and/or a combination of both. As an example, the user devices 104 may connect with the server 102 over the Internet.

As mentioned above, the server 102 may be configured to render stream an environment to the plurality of user devices 104. According to an embodiment of the present subject matter, the server 102 may be configured to perform the render streaming in a manner such that a personalized experience of the environment is provided to each of the user devices 104. In other words, the changes done to the environment by one user device, say, user device 104-1 does not reflect on the environment experience of the other user devices, say, user devices 104-2, 104-3, . . . , and 104-N. This facilitates in enhancing the user experience as unwarranted changes from other users are not reflected in the scene of a user. Furthermore, privacy of user sessions is also maintained as the changes in the scene done by a user are not shown to other users.

For availing the render streaming services relating to the environment, in an example, each of the user devices 104 may first establish a connection with the server 102. Accordingly, each of the user devices 104 may be configured to send a connection establishment request to the server 102 over the network 106. The connection establishment request, as may be understood, may be sent over the network 106 using any of the transmission protocols supported by the network 106. In an example, the connection establishment request may include amongst other things, request to create a connection with the server 102, a device type of the user device, connection parameters, authentication information, etc. In an example, the server 102 may be configured to establish an active connection with each of the plurality of user devices 104, in response to receiving the connection establishment request from the user devices 104. Furthermore, in an example implementation, the server 102 may be configured to receive the connection requests and provide the render streaming services to multiple user devices 104 concurrently. As may be understood, a maximum number of connections supported by the server 102 may be dependent on the hardware configuration of the server. In an example and without limitation, the server 102 may be of such a hardware configuration that render streaming may be provided to a maximum of twenty-two user devices 104.

Once the connection is established, the server 102 may be configured to render the scenes from the environment to the user devices 104. In an example, the server 102 may provide a spawned camera to each of the plurality of user devices 104 to show the scenes of the environment to the user devices 104 from a respective point of view (POV). In an example, the scene received by the plurality of user devices 104 may include a plurality of instances. As may be understood, an instance may pertain to an object in the scene, for example, in case of a virtual showroom for cars, each of the cars may refer to a different instance. Further, in an example, change of property of each car, i.e., different POV, color, etc. may be a different instance. Further, in an example of VR gaming, selection of different characters/avatars may refer to a different instance.

In an example embodiment, the server 102 may be configured to generate a plurality of unique layers corresponding to each of the plurality of user devices 104-1, 104-2, . . . , 104-N upon establishment of the active connections. For example, if there are N connected users to the server 102, the server 102 may generate N unique layer, where a unique layer is assigned to each of the N users. A layer, as used herein, may be understood as an imaging layer comprising a set of instances corresponding to the scene of the environment being rendered to a user device 104. In an example, as soon as the connection is built, the server 102 may be configured to generate a default layer which includes all the instances corresponding to the scene of the environment.

In the above embodiment, the layers generated by the server 102 may be customizable. In other words, the server 102 may be configured to modify, add, and/or delete instances from the unique layers based on corresponding update requests from the user devices 104. Thus, the changes done by a user device, say, the user device 104-1 are reflected only in the corresponding unique layer of the user device 104-1, and not in the layers of the other user devices 104.

In an embodiment, the server 102 may be configured to render scenes from the environment to the plurality of user devices 104 based on the respective unique layers corresponding to the user devices 104. Thus, as the scenes are rendered to the user devices 104 based on respective unique layers, a unique experience of the environment is provided to the users of the user devices 104.

In operation, the server 102 may be configured to obtain a 3D scene corresponding to the environment and generate a plurality of draw calls for a plurality of instances in the 3D scene. Subsequently, according to an embodiment of the present subject matter, the server 102 may be configured to filter the plurality of generated draw calls based on the plurality of unique layers corresponding to the user devices 104 to obtain a plurality of unique draw call sets corresponding to the user devices 104. These unique draw call sets are subsequently used by the server 102 to generate a set of render textures corresponding to each of the plurality of user devices 104. In an example, render texture may refer to a specific type of texture used in computer graphics rendering wherein the texture is an image or a data array applied to the surfaces of 3D objects to provide visual detail, such as colours, patterns, or materials.

Continuing with the above embodiment, the corresponding set of rendered textures are subsequently streamed to the respective user devices 104. In an example implementation, the server 102 may be configured to render the set of unique rendered textures to the respective user devices over the corresponding active connections.

As an example, the server 102 may be implemented by an enterprise to render a virtual car showroom to users who may login using user devices, such as a web browser, a smartphone, and a tablet. Consider that in the present example, five users have established the virtual car showroom and are render streaming concurrently. According to the aspects of the present subject matter, the server 102 may be configured to generate and maintain a unique layer for the five users, and changes done by the users will be reflected in their unique layer only. For instance, a user 1 may select red color for the vehicle and a user 2 may select blue color for the same vehicle. Now, as per the present subject matter, the server 102 will take the base draw call set corresponding to the scene of the virtual car showroom and filter for user 1 and user 2, as per their respective layers. Accordingly, a draw call set 1 would be generated for user 1 in which the object car would be of red color, and likewise in the draw call set 2, the object car would be of blue color. Based on these respective draw call sets 1 and 2, the server 102 will generate respective render textures and transmit the same to the user 1 and user 2 respectively. Thus, in such a way the experience of the virtual car showroom is not shared amongst the five users and each user is provided with a unique experience of the virtual car showroom through a single server, i.e., the server 102.

According to an embodiment, the server 102 may be further configured to establish unique data and/or audio channels for the respective user devices 104. Thus, the data and audio transmitted/received from the respective user devices 104 are also kept isolated, resulting in an entirely personalized experience for the user devices 104.

In an example use case implementation, the user devices 104 and the server 102 may be pertain to a single enterprise. For instance, a gaming enterprise may manufacture user devices, such as VR headsets, gaming consoles, etc., and may also implement a server, such as the server 102, for render streaming environment to the user devices. In another example use case implementation, the user devices 104 and the server 102 may pertain to different enterprises. For instance, the user devices may be a smartphone, a laptop, a tablet of a single or different manufacturers. These devices may be used to access a virtual showroom being rendered by an enterprise using a server, such as the server 102. Thus, the server 102 and the plurality of user devices 104-1 to 104-N, in an example, may operate as a system for rendering the environment to the plurality of user devices 104-1 to 104-N.

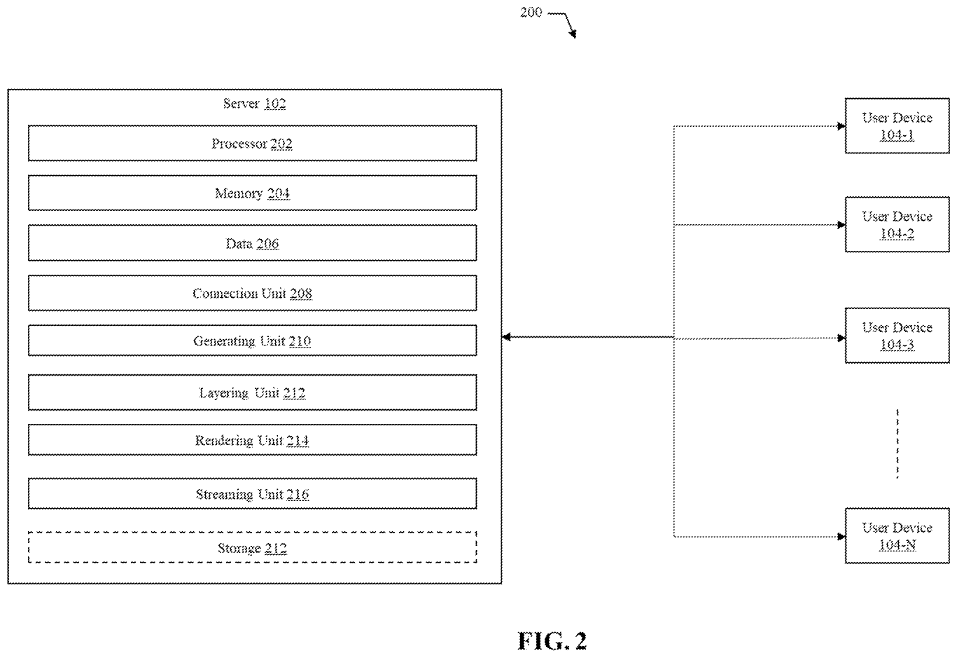

FIG. 2 illustrates a schematic block diagram 200 of the server 102, according to an example embodiment of the present subject matter. In an example, the processor 202 may be a single processing unit or a number of units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The data 206 serves, amongst other things, as a repository for storing data processed, received, and generated by one or more of the processors 202. Writing further, in a non-limiting manner, one or more of the aforementioned components of the server 102 may send or receive data, for example, using one or more input/output ports and one or more user devices.

The connection unit 208, the generating unit 210, the layering unit 212, the rendering unit 214 and the streaming unit 216, amongst other things, include routines, programs, objects, components, data structures, etc., which perform particular tasks or implement data types. Said units may also be implemented as, signal processor(s), state machine(s), logic circuitries, and/or any other device or component that manipulate signals based on operational instructions.

Further, the units can be implemented in hardware, instructions executed by a processing unit, or by a combination thereof. The processing unit can comprise a computer, a processor, such as the processor 202, a state machine, a logic array or any other suitable devices capable of processing instructions.

In another aspect of the present subject matter, the units may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

In an example, the server 102 may include or may be communicatively coupled with a storage 212. The storage 212 may be either an internal storage or an external storage. In an example, a plurality of users may seek access to an environment using the plurality of user devices 104-1, 104-2, 104-3 . . . , 104-N, respectively. Examples of the environment may include, a Virtual Reality (VR) environment, an Augmented Reality (AR) environment, a Mixed Reality (MR) environment, and a 3D environment, etc. For seeking the access, the user devices 104 may send a corresponding connection establishment request to the server 102.

According to an example embodiment of the present subject matter, the connection unit 208, coupled to the processor 202, may be configured to establish an active connection with each of the plurality of user devices 104-1, 104-2, 104-3 . . . , 104-N, in response to receiving the corresponding connection establishment request from the plurality of user devices 104-1, 104-2, 104-3 . . . , 104-N. In an example, the connection unit 208, may be configured to process the connection establishing request received from the plurality of user devices 104-1, 104-2, 104-3 . . . , 104-N in a pipeline manner, where the connection establishment requests received from each of the user devices 104 may be processed in the order of the receiving of the requests from said user devices 104, and the respective connections may be established accordingly. In an implementation, the connection unit 208 may be configured to support multiple active connections, based on a hardware configuration of the server 102. In other words, the connection unit 208 may be configured to support multiple active connections with the user devices 104, simultaneously.

In an example embodiment, the layering unit 212, coupled to the processor 202, may be configured to generate a plurality of unique layers corresponding to the plurality of user devices 104-1, 104-2, 104-3 . . . , 104-N, upon establishment of the active connections. Each unique layer may be understood as a graphical layer including a plurality of instances corresponding to a scene of the environment. In an example, the layer unit 212 may generate the layers such that a default unique layer is first generated upon connection establishment with a respective user device 104. Subsequently, the layer unit 212 may be configured to maintain the unique layer corresponding to the user device 104. That is, the layer unit 212 may be configured to add instances, remove instances, and modify instances in the unique layer, based on respective such requests, when received from the user device 104. In an example, the unique layers generated and maintained by the layering unit 212 may be used during the render streaming of the scene of the environment to the user devices 104. As the layers are unique to each of the user devices 104, a personalized experience is provided to the user devices 104.

In an example embodiment, the generating unit 210, coupled to the processor 202 may be configured to obtain a 3D scene corresponding to the environment. In operation, the generating unit 210 may be configured to generate a plurality of draw calls for a plurality of instances in the 3D scene. The generated draw calls, in an example, may be stored in the storage 212 by the generating unit 210.

In an example embodiment, the layering unit 212, coupled to the processor 202, may be configured to obtain the plurality of generated draw calls corresponding to the 3D scene from the storage 212. In said embodiment, the layering unit 212 may be configured to filter the plurality of generated draw calls based on the plurality of unique layers corresponding to the user devices 104 to obtain a plurality of unique draw call sets corresponding to the plurality of user devices 104.

In an implementation, for the filtering of the plurality of draw calls, the layering unit 212 may identify the instances included in a unique layer, say unique layer 1, corresponding to the user device 104-1. Once the instances included in the unique layer 1 are identified, the layering unit 212 may be configured to select only the draw calls corresponding to the instances included in the unique layer 1 and generate a corresponding unique draw call set 1 for the user device 104-1. Thus, in said manner, the layering unit 212 identifies and filters the draw calls based on the unique layers. As may be understood, the filtering of the draw calls to generate the unique draw call sets is performed for all the user devices 104 that are connected to the server 102.

Once the unique draw call set for each of the user devices 104 is generated, the rendering unit 214 may be configured to generate a set of render textures corresponding to each of the plurality of user devices 104 based on the unique draw call sets associated with the respective user devices 104. The set of render texture may include a render texture for each object in the scene, in an example. In another example, the set of render texture may include a render texture for the whole scene.

After the set of rendered textures corresponding to the user devices 104 are generated, the streaming unit 216 may be configured to stream the corresponding set of rendered textures to the respective user devices 104. In the embodiment, the streaming unit 216 coupled to the processor 202 may be configured to render the corresponding set of render textures to the respective user devices through the respective active connections. According to the embodiment, the rendered output from the streaming unit 216 to one user device may not be reflecting to the remaining user devices connected to the server 102 experiencing the same environment.

In an example embodiment, the layering unit 210 coupled to the processor 202 may be further configured to receive a first scene update request and a second scene update request from a first user device and a second user device, from the plurality of user devices, respectively. The scene update request may be understood a request to update one or more instances in the 3D scene.

In the above example embodiment, the layering unit 212 may be configured to update a first unique layer and a second unique layer corresponding to the first device and the second device, respectively, based on the first scene update request and the second scene update request, respectively. For instance, consider a case where the first scene update request is a request to delete two instances and the second scene update request is a request to add two instances. Accordingly, the layering unit 212 may be configured to remove two instances from the first unique layer and add two instances in the second unique layer.

Subsequently, the layering unit 212 may be configured to update a first set of draw calls corresponding to the first user device and update a second set of draw calls corresponding to the second user device, based on the updated first unique layer and the updated second unique layer, respectively.

Furthermore, in the said embodiment, the rendering unit 214 may be configured to generate a first updated set of render textures and a second updated set of render textures based on the updated first set of draw calls and the updated second set of draw calls. In an embodiment, the rendering unit 214 coupled to the processor 202 may generate the updated set of render textures based on the updated first set of draw calls and the updated second set of draw calls from the layering unit 212 for further streaming to the respective first user device and second user device.

In an example embodiment, the layering unit 212 is further configured to assign a unique audio channel to each of the plurality of user devices 104-1, 104-2, 104-3 . . . , 104-n upon receiving the connection establishment request from the plurality of user devices 104-1, 104-2, 104-3 . . . , 104-N. The layering unit 212 coupled to the processor 202 may be configured to transmit/receive audio communication of the corresponding user device with the server 102 over the established unique audio channel. In the embodiment, each of the plurality of user devices 104-1, 104-2, 104-3 . . . , 104-N may get personalised experience.

In an example embodiment, the layering unit 212 is further configured to assign a unique data channel to each of the plurality of user devices 104-1, 104-2, 104-3 . . . , 104-n upon receiving the connection establishment request from the plurality of user devices 104-1, 104-2, 104-3 . . . , 104-N. The layering unit 212 coupled to the processor 202 may be configured to transmit/receive data communication of the corresponding user device with the server 102 over the established unique data channel. In the embodiment, each of the plurality of user devices 104-1, 104-2, 104-3 . . . , 104-N may get personalised experience.

In one embodiment, the rendering unit 214 may be further configured to obtain user device type information from a database which may be stored in the storage 212. The device type information may include information about a device type of each of the plurality of user devices 104. In an example, the database may be in the form of a list of user devices 104 and their respective device type may be stored against the respective user devices. In an example, the connection unit 208 may obtain the device type data from the user devices 104 during the connection establishment and may store the same in the database.

Once the user device type information is obtained, the rendering unit 214 may be configured to identify a respective type of the user devices 104. In an example, the types of user devices may include, but are not limited to a laptop, a smartphone, a desktop, a Virtual Reality (VR) device, a device supporting Augmented Reality (AR), and a device supporting Mixed Reality (MR).

Subsequently, the rendering unit 214 may be configured to generate, for each of the plurality of user devices, the set of render texture based on the respective unique draw call set and the respective type of the user device. Accordingly, the generated set of render textures may render streamed to the respective user devices 104.

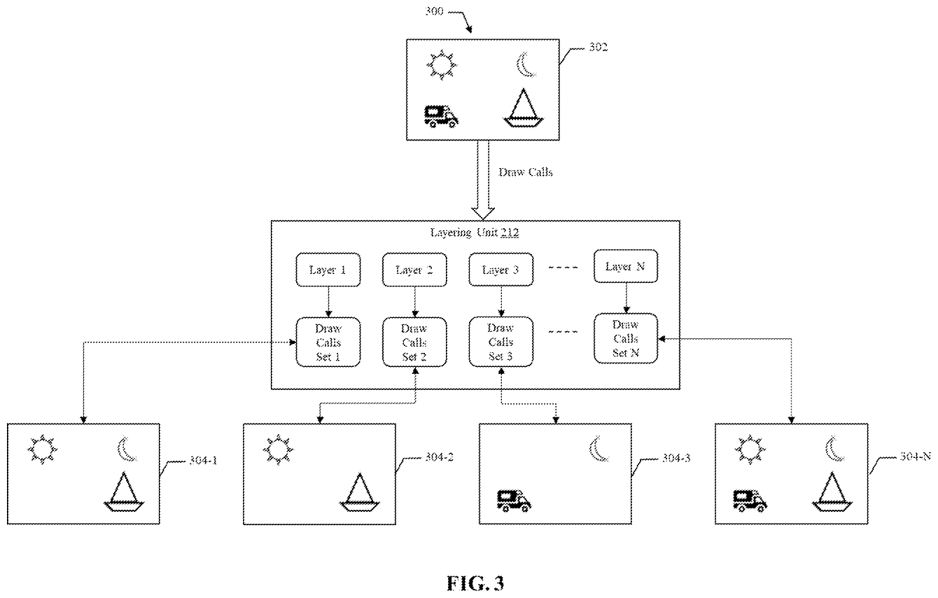

FIG. 3 illustrates an operational flow diagram 300 of the layering unit for render streaming an environment to a plurality of user devices, according to one or more embodiments of the present subject matter. In the embodiment, a scene 302 for rendering to the user devices 104-1, 104-2, 104-3 and 104-N is depicted. In an example, the scene 302 may include a plurality of instances, such as a sun, a moon, a ship and a vehicle. In operation, for rendering the scene 302 to the user devices 104, the server 102 may be configured to generate a plurality of draw calls for the plurality of instances. These generated draw calls are passed to the layering unit 212 of the server 102.

As mentioned above in the description of FIGS. 1 and 2, the layering unit 212 generates a set of unique layers corresponding to each of the user devices 104-1, 104-2, 104-3 . . . , 104-N. As shown in the FIG., layer 1 corresponds to user device 104-1, layer 2 corresponds to user device 104-2, layer 3 corresponds to user device 104-3 and layer N corresponds to user device 104-N. The layering unit 212, in an example, may obtain the generated draw calls and may filter the generated draw calls based upon the plurality of unique layers to obtain a plurality of unique draw call sets corresponding to the user devices 104. For example, as shown in the figure, draw call set 1 corresponds to user device 104-1 and includes one or more draw calls filtered from the set of draw calls based on the layer 1, draw call set 2 corresponds to user device 104-2 and includes one or more draw calls filtered from the set of draw calls based on the layer 2, and so on and so forth.

Once the filtering of the set of draw calls is done and respective unique draw call sets are obtained, corresponding set of render textures for the plurality of user devices 104 may be generated based on the respective unique draw call sets and streamed to the user devices 104. Based on the these set of render textures received at the user devices 104, a respective personalized scene may be created at the user devices 104. For instance, based on the corresponding set of render textures received at the user device 104-1, a scene 304-1 may be generated and displayed using the user device 304-1. Likewise, based on the corresponding set of render textures received at the user device 104-2, a scene 304-2 may be generated and displayed using the user device 304-2, and so on and so forth.

In the embodiment, user device 104-1 may be outputted with scene 304-1 comprising render textures for sun, moon and ship. Similarly, user device 104-2 may be outputted with the scene 304-2 comprising render textures for sun and ship. Further, the user device 104-3 may be outputted with the scene 304-3 comprising render textures for vehicle and moon. Further, the user device 104-N may be outputted with the scene 304-N comprising render textures for sun, moon, vehicle and ship. In the embodiment, with the layering unit 212, each of the user devices 104-1, 104-2, 104-3 and 104-N may get personalised experience, i.e., the instances requested by one user device, say user device 104-1 may not be visible to the remaining user devices 104-2, 104-3 and 104-N experiencing the same environment and the same scene.

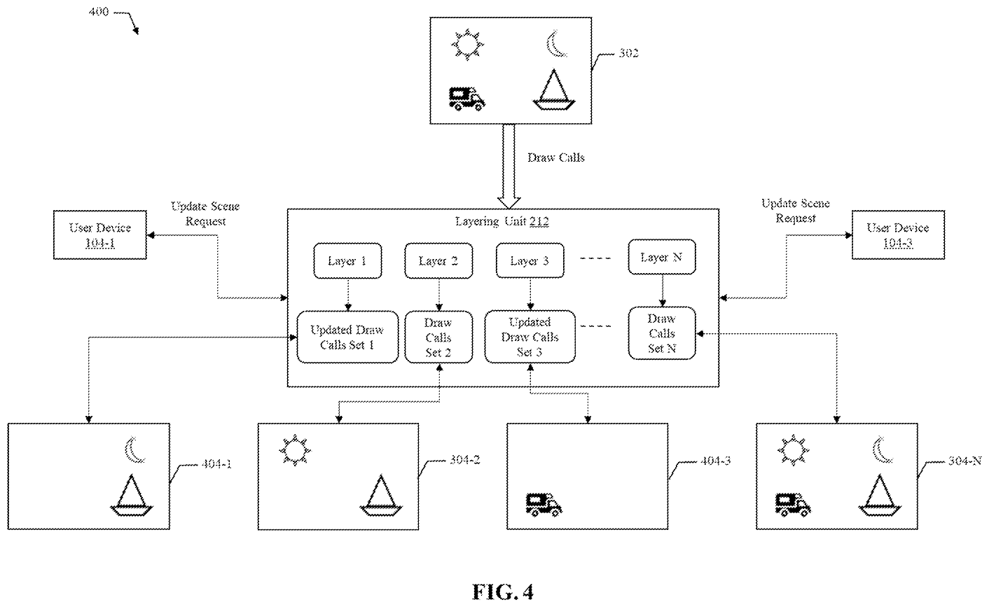

FIG. 4 illustrates an operational flow diagram 400 indicating handling of update request by the server for render streaming an environment to a plurality of user devices, according to one or more embodiments of the present subject matter. In the embodiment, the user devices 104-1 and 104-3 may request for update of one or more instances in the scene 302. The update in an example may be addition of one or more instances in the scene. In another example, the updation may be removal of one or more instances from the scene. In yet another example, the updation may include modifying the one or more instances in the scene. In the example illustration, based upon the scene update request from the user devices 104-1 and 104-3, the layering unit may update layer 1 corresponding to the user device 104-1 and update layer 3 corresponding to the user device 104-3, respectively. The updated layer 1 and layer 2 may now have the information of the updated instances selected by the respective user devices 104-1 and 104-3.

Further, the layering unit 212 may update draw call set for user 104-1 as updated draw call set 1 and may and update draw call set for user 104-3 as updated draw call set 3 based on the updated unique layer 1 and the updated unique layer 3, respectively. In said embodiment, updated draw calls set 1 comprises updated one or more draw calls requested by the user device 104-1 and updated draw calls set 3 comprises updated one or more draw calls requested by the user device 104-3.

Subsequently, the set of render textures corresponding to the user device 104-1 and the 104-3 are updated and streamed to the user devices, respectively. Using the updated set of render textures, updated scenes may be generated and displayed on the user device 104-1 and the user device 104-3. For instance, as shown, the user device 104-1 may be outputted with updated scene 404-1 comprising updated render textures for moon and ship and the user device 104-3 may be outputted with updated scene 404-3 comprising updated render textures for vehicle. Thus, with the implementation of the layering unit 212 according to embodiments of the present subject matter, each of the user devices 104-1, 104-2, 104-3 and 104-N may get personalised experience, i.e., the update requested by one user device, say 104-1 may not be reflected to the remaining user devices, say 104-2, 104-3 and 104-N experiencing the same environment and the same scene.

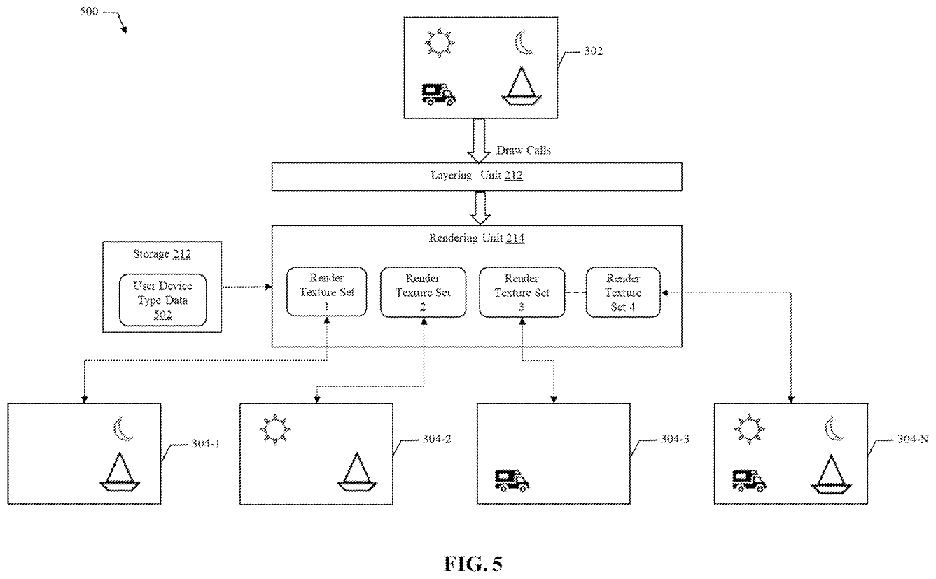

FIG. 5 illustrates a block diagram 500 of the server indicating flow of operations performed for render streaming an environment to a plurality of user devices for the various user device types, according to one or more embodiments of the present subject matter. Without limitation, the user device may be one of a laptop, a smartphone, a desktop, a Virtual Reality (VR) device, a device supporting Augmented Reality (AR), and a device supporting Mixed Reality (MR). In an example embodiment, the rendering unit 212 may obtain the information associated with the types of user devices 104-1, 104-2, 104-3, 104-N from the database which may be stored in the storage 212. As mentioned previously, the information about the type of the user device may be obtained during the connection establishment and stored in the database as device type information. This information, in an embodiment, may be used for adapting/configuring the render textures prior to streaming them, as per the type of the user device 104.

In operation, after obtaining the user device type information from the storage 212, the rendering unit 214 may be configured to identify a respective type of the user devices 104. Accordingly, in an example embodiment, the rendering unit 214 may be configured to configure/adapt the corresponding set of render textures of the user devices 104, based on their identified device types. Subsequently, the configured/adapted set of render textures are streamed to the respective user devices 104-1, 104-2, 104-3 and 104-N. As may be understood, in an example, different device types may have different computational power, GPU capabilities, display characteristics, network bandwidth, and input methods. Accordingly, by rendering the render textures considering the user device type, the server 102 optimizes the rendering process and delivers an improved and high quality visual experience on each device type.

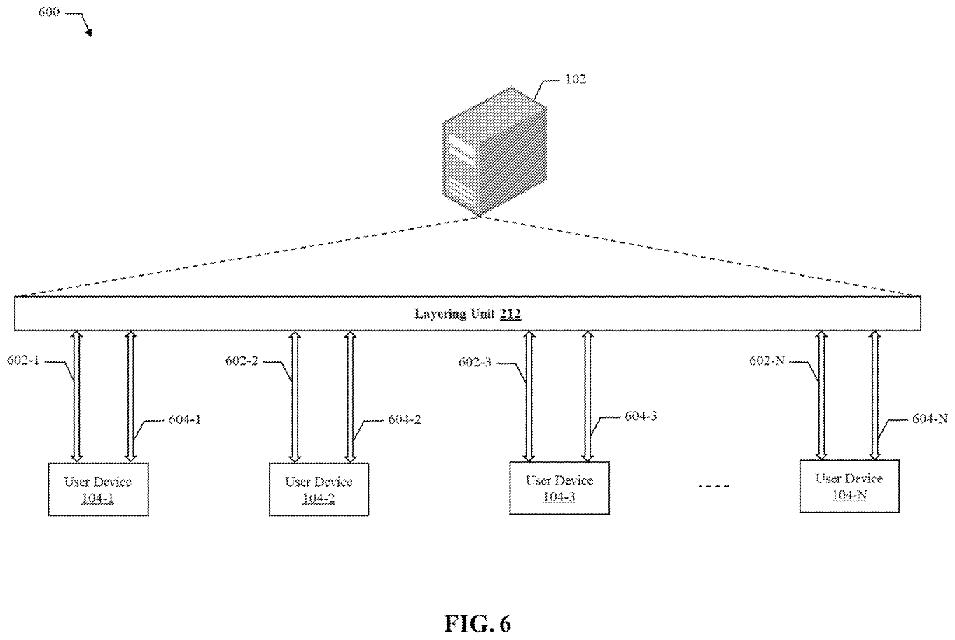

FIG. 6 illustrates a block diagram 600 depicting various channels established between the server and each of the plurality of user devices for render streaming, according to one or more embodiments of the present subject matter. In an example embodiment, upon establishment of the connections of the user devices 104 with the server 102, the layering unit 212 may assign a unique audio channel to each of the plurality of user devices 104-1, 104-2, 104-3 and 104-N. For instance, as shown in the figure, the layering unit 212 may assign the audio channels 602-1, 602-2, 602-3, and 602-N to the user devices 104-1, 104-2, 104-3, and 104-N, respectively. Accordingly, the layering unit 212 may transmit or receive the audio communication related to user device 104-1 over the established unique audio channel 602-1. Similarly, the layering unit 212 may transmit or receive the audio communication related to user device 104-2 over the established unique audio channel 602-2. Further, the layering unit 212 may transmit or receive the audio communication related to user device 104-3 over the established unique audio channel 602-3. Further, the layering unit 212 may transmit or receive the audio communication related to user device 104-N over the established unique audio channel 602-N.

Furthermore, in an embodiment, once the connection of the user devices 104-1, 104-2, 104-3, and 104-N is established with the server 102, the layering unit 212 may assign a unique data channel to each of the plurality of user devices 104-1, 104-2, 104-3 and 104-N. For instance, as shown in the figure, the layering unit 212 may assign the data channels 604-1, 604-2, 604-3, and 604-N to the user devices 104-1, 104-2, 104-3, and 104-N, respectively. Accordingly, the layering unit 212 may transmit or receive the data communication related to user device 104-1 over the established unique data channel 604-1. Similarly, the layering unit 212 may transmit or receive the data communication related to user device 104-2 over the established unique data channel 604-2. Further, the layering unit 212 may transmit or receive the data communication related to user device 104-3 over the established unique data channel 604-3. Further, the layering unit 212 may transmit or receive the data communication related to user device 104-N over the established unique data channel 604-N. According to the present embodiment, keeping the data and audio transmitted/received from the connected user devices isolated from each other may result into an entirely personalized experience for each of the plurality of user devices 104.

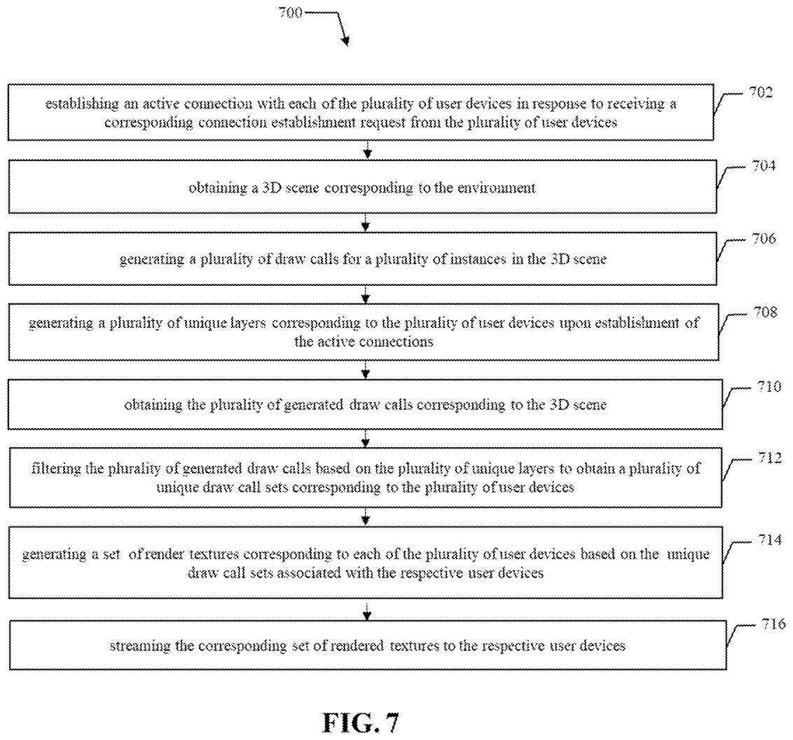

FIG. 7 illustrates a flowchart of a method 700, according to an embodiment of the present subject matter. In an example, the method 700 may be implemented in the server 102. Furthermore, details of the steps of the method 700 which are already described herein in the above figures are not included in detail herein.

At step 702, the method 700 includes establishing by the server 102 an active connection with each of the plurality of user devices 104-1, 104-2, . . . , 104-N in response to receiving a corresponding connection establishment request from the plurality of user devices 104-1, 104-2, . . . , 104-N. The connection establishment request may be received from the user of the user device by entering the associated login details from the user device for experiencing an environment. In one example, in case the environment is VR showroom, the user device may be VR glasses setup for experiencing said environment. Upon wearing the virtual glasses, the connection establishment request may be sent to the server 102, once the user enters the login details. Subsequently, the server 102 verifies the user's identity and checks whether user has the necessary permissions to access the VR content and features offered by the showroom. Upon verification of the details, the VR glasses are connected to the VR showroom and the user may now experience the environment. Similarly, the plurality of user devices 104-1, 104-2, . . . , 104-N may send the connection establishment request to the server 102 simultaneously or at different times for experiencing the same or different environment. In an example, the step may be performed by the connection unit 208 coupled to the processor 202.

At step 704, the method 700 includes obtaining by the server 102, a 3D scene corresponding to the environment. Examples of 3D scene in case the selected environment is VR game is VR Heads-Up Display (HUD), virtual mirrors and size and fit guides in case the selected environment is virtual showroom, etc. In an example, the step may be performed by the generating unit 210 coupled to the processor 202.

At step 706, the method 700 includes generating by the server 102, a plurality of draw calls for a plurality of instances in the 3D scene. For example, in case of virtual showroom environment, an instance may be a plurality of sarees arranged in plurality of sections based upon color, fabric, etc. The server 102 may be configured to generate 2D draw calls for the visual representation of the garment accordingly, allowing users to visualize how different color options, fabric option would look.

At step 708, the method 700 includes generating by the server 102, a plurality of unique layers corresponding to the plurality of user devices 104-1, 104-2, . . . , 104-n upon establishment of the active connections. In the embodiment, for the plurality of user devices 104-1, 104-2, . . . , 104-n connected to the server 102, the server 102 may generate N unique layer, wherein one layer corresponds to each of the N users. In an example, the step may be performed by the layering unit 212 coupled to the processor 202.

At step 710, the method 700 includes obtaining by the server 102, the plurality of generated draw calls corresponding to the 3D scene. The generated draw calls corresponding to the plurality of instances are fetched from the generating unit 210. In an example, the step may be performed by the layering unit 212 coupled to the processor 202.

At step 712, the method 700 includes filtering by the server 102, the plurality of generated draw calls based on the plurality of unique layers to obtain a plurality of unique draw call sets corresponding to the plurality of user devices 104-1, 104-2, . . . , 104-N. The fetched draw calls are filtered using the unique layers so that the unique draw call sets thus obtained after filtering may include only the draw calls for the instances that a user wishes to see. For example, user 1 selects instance N1 and N2 in a scene and user 2 selects instance N1, N4 and N5 in the scene. The method may generate two unique draw call sets in which, the unique draw call set 1 may include instances N1 and N2 and not N4 and N5, and a unique draw call set 2 which includes instances N1, N4, and N5, but not N2. In an example, the step may be performed by the layering unit 212 coupled to the processor 202. These unique draw call sets are subsequently used for render texture generation which personalizes the user experiences.

At step 714, the method 700 includes generating by the sever 102, a set of render textures corresponding to each of the plurality of user devices based on the unique draw call sets associated with the respective user devices. In an example, the step may be performed by the rendering unit 214 coupled to the processor 202.

At step 716, the method 700 includes streaming by the server 102, the corresponding set of rendered textures to the respective user devices. The set of rendered textures may be rendered to respective user devices. In an example, the step may be performed by the streaming unit 216 coupled to the processor 202.

Furthermore, in the method 700, in an example embodiment, a first unique layer and a second unique layer corresponding to the first device and the second device, respectively, may be updated based on a first scene update request and a second scene update request. In an example, the step may be performed by the layering unit 212 coupled to the processor 202. For instance, consider a case where the first scene update request is a request to delete two instances and the second scene update request is a request to add two instances. Accordingly, the layering unit 212 may be configured to remove two instances from the first unique layer and add two instances in the second unique layer.

Subsequently, a first set of draw calls corresponding to the first user device is updated and a second set of draw calls corresponding to the second user device may be updated, based on the updated first unique layer and the updated second unique layer, respectively. In an example, the step may be performed by the layering unit 212 coupled to the processor 202.

Furthermore, in the method 700, in the said embodiment, a first updated set of render textures and a second updated set of render textures may be generated based on the updated first set of draw calls and the updated second set of draw calls. In the embodiment, the updated set of render textures may be generated based on the updated first set of draw calls and the updated second set of draw calls received from the layering unit 212 for further streaming to the respective first user device and second user device. In an example, the step may be performed by the rendering unit 214 coupled to the processor 202.

In an example embodiment, the method 700 further comprises assigning a unique audio channel to each of the plurality of user devices 104-1, 104-2, 104-3 . . . , 104-n upon receiving the connection establishment request from the plurality of user devices 104-1, 104-2, 104-3 . . . , 104-N. In an example, the step may be performed by the rendering unit 214 coupled to the processor 202. The method further comprises transmitting/receiving audio communication of the corresponding user device with the server 102 over the established unique audio channel. In an example, the step may be performed by the layering unit 212 coupled to the processor 202. In the embodiment, each of the plurality of user devices 104-1, 104-2, 104-3 . . . , 104-N may get personalised experience.

In an example embodiment, the method 700 further comprises assigning a unique data channel to each of the plurality of user devices 104-1, 104-2, 104-3 . . . , 104-n upon receiving the connection establishment request from the plurality of user devices 104-1, 104-2, 104-3 . . . , 104-N. In an example, the step may be performed by the rendering unit 214 coupled to the processor 202. The method further comprises transmitting/receiving data communication of the corresponding user device with the server 102 over the established unique data channel. In an example, the step may be performed by the layering unit 212 coupled to the processor 202. In the embodiment, each of the plurality of user devices 104-1, 104-2, 104-3 . . . , 104-N may get personalised experience.

In an embodiment, the method 700 further comprises obtaining an information associated with the types of user devices type information from a database, wherein the user device type information comprises information about a device type of each of the plurality of user devices, wherein the device type is one of: a laptop, a smartphone, a desktop, a Virtual Reality (VR) device, a device supporting Augmented Reality (AR), and a device supporting Mixed Reality (MR). The method further comprises generating for each of the plurality of user devices the set of render textures based on the respective unique draw call set and the respective a type of the user device. In the embodiment, the rendering unit 214 may receive the user device type information from the database in the storage 212. Accordingly, the generated set of render textures may render streamed onto the respective user devices. In an example, the steps may be performed by the rendering unit 214 coupled with the processor 202. Subsequently, the rendering unit 214 may be configured to generate, for each of the plurality of user devices, the set of render texture based on the respective unique draw call set received from the layering system 212 and the respective type of the user device.

The rendering unit coupled with the processor 202 may generate the set of render textures for the respective user devices based upon the user device information received from the database and the draw call sets associated with the respective user devices from the layering unit 212.

The foregoing descriptions of exemplary embodiments of the present disclosure have been presented for purposes of illustration and description. They are not intended to be exhaustive or to limit the disclosure to the precise forms disclosed, and obviously many modifications and variations are possible in light of the above teaching. The exemplary embodiment was chosen and described in order to best explain the principles of the disclosure and its practical application, to thereby enable others skilled in the art to best utilize the disclosure and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present disclosure.

The present system leads to various advantages such as data consumption is reduced to fractions in comparison to the existing solutions. Further, the disclosed system for render streaming with concurrent users is cost effect and reduces the latency. Further, less hardware circuitry is required for the implementation purposes. Also, one server, is able to deliver “n” number of experiences without the need for scaling the server vertically or horizontally.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While specific language has been used to describe the disclosure, any limitations arising on account of the same are not intended. As would be apparent to a person in the art, various working modifications may be made to the apparatus in order to implement the inventive concept as taught herein.

We claim:

1. A server for render streaming an environment to a plurality of user devices, wherein the server comprises:
a processor;
a connection unit coupled to the processor, wherein the connection unit is configured to establish an active connection with each of the plurality of user devices in response to receiving a corresponding connection establishment request from the plurality of user devices;
a generating unit coupled to the processor, wherein the generating unit is configured to:
obtain a 3D scene corresponding to the environment; and
generate a plurality of draw calls for a plurality of instances in the 3D scene;
a layering unit coupled to the processor, wherein the layering unit is configured to:
generate a plurality of unique layers corresponding to the plurality of user devices upon establishment of the active connections;
obtain the plurality of generated draw calls corresponding to the 3D scene; and
filter the plurality of generated draw calls based on the plurality of unique layers to obtain a plurality of unique draw call sets corresponding to the plurality of user devices;
a rendering unit coupled to the processor, wherein the rendering unit is configured to generate a set of render textures corresponding to each of the plurality of user devices based on the unique draw call sets associated with the respective user devices; and
a streaming unit coupled to the processor, wherein the streaming unit is configured to stream the corresponding set of rendered textures to the respective user devices.

2. The server as claimed in claim 1, wherein:
the layering unit coupled to the processor is further configured to:
receive a first scene update request and a second scene update request from a first user device and a second user device, from the plurality of user devices, respectively, wherein the scene update request is a request to update one or more instances in the 3D scene;
update a first unique layer and a second unique layer corresponding to the first device and the second device based on the first scene update request and the second scene update request, respectively; and
update a first set of draw calls and a second set of draw calls corresponding to the first user device and the second user device, based on the updated first unique layer and the updated second unique layer, respectively;
the rendering unit coupled to the processor is further configured to generate a first updated set of render textures and a second updated set of render textures based on the updated first set of draw calls and the updated second set of draw calls, respectively.

3. The server as claimed in claim 1, wherein the layering unit coupled to the processor is further configured to:
assign a unique audio channel to each of the plurality of user devices upon receiving the connection establishment request from the plurality of user devices; and
transmit/receive audio communication of the corresponding user device with the server over the established unique audio channel.

4. The server as claimed in claim 1, wherein the layering unit coupled to the processor is further configured to:
assign a unique data channel to each of the plurality of user devices upon receiving the connection establishment request from the plurality of user devices; and
transmit/receive data communication of the corresponding user device with the server over the established unique data channel.

5. The server as claimed in claim 1, wherein the rendering unit coupled to the processor is further configured to:
obtain user device type information from a database, wherein the user device type information comprises information about a device type of each of the plurality of user devices, wherein the device type is one of: a laptop, a smartphone, a desktop, a Virtual Reality (VR) device, a device supporting Augmented Reality (AR), and a device supporting Mixed Reality (MR);
identify, for each of the plurality of user devices, a respective type of the user device based on the obtained user device type information; and
generate, for each of the plurality of user devices, the set of render textures based on the respective unique draw call set and the respective type of the user device.

6. A method for render streaming an environment to a plurality of user devices, wherein the method comprises:
establishing, by a connection unit coupled to a processor, an active connection with each of the plurality of user devices in response to receiving a corresponding connection establishment request from the plurality of user devices;
obtaining, by a generating unit coupled to the processor, a 3D scene corresponding to the environment;
generating, by the generating unit coupled to the processor, a plurality of draw calls for a plurality of instances in the 3D scene;
generating, by a layering unit coupled to the processor, a plurality of unique layers corresponding to the plurality of user devices upon establishment of the active connections;
obtaining, by the layering unit coupled to the processor, the plurality of generated draw calls corresponding to the 3D scene;
filtering, by the layering unit coupled to the processor, the plurality of generated draw calls based on the plurality of unique layers to obtain a plurality of unique draw call sets corresponding to the plurality of user devices;
generating, by a rendering unit coupled to the processor, a set of render textures corresponding to each of the plurality of user devices based on the unique draw call sets associated with the respective user devices; and
streaming, by a streaming unit coupled to the processor, the corresponding set of rendered textures to the respective user devices.

7. The method as claimed in claim 6, wherein the method further comprises:
receiving, by the layering unit coupled to the processor, a first scene update request and a second scene update request from a first user device and a second user device, from the plurality of user devices, respectively, wherein the scene update request is a request to update one or more instances in the 3D scene;
updating, by the layering unit coupled to the processor, a first unique layer and a second unique layer corresponding to the first device and the second device based on the first scene update request and the second scene update request, respectively;
updating, by the layering unit coupled to the processor, a first set of draw calls and a second set of draw calls corresponding to the first user device and the second user device, based on the updated first unique layer and the updated second unique layer, respectively; and
generating, by the rendering unit coupled to the processor, a first updated set of render textures and a second updated set of render textures based on the updated first set of draw calls and the updated second set of draw calls, respectively.

8. The method as claimed in claim 6, wherein the method comprises:
assigning, by the layering unit coupled to the processor, a unique audio channel to each of the plurality of user devices upon receiving the connection establishment request from the plurality of user devices; and
transmitting/receiving, by the layering unit coupled to the processor, audio communication of the corresponding user device with the server over the established unique audio channel.

9. The method as claimed in claim 6, wherein the method comprises:
assigning, by the layering unit coupled to the processor, a unique data channel to each of the plurality of user devices upon receiving the connection establishment request from the plurality of user devices; and
transmitting/receiving, by the layering unit coupled to the processor, data communication of the corresponding user device with the server over the established unique data channel.

10. The method as claimed in claim 6, wherein the method further comprises:
obtaining, by the rendering unit coupled to the processor, user device type information from a database, wherein the user device type information comprises information about a device type of each of the plurality of user devices, wherein the device type is one of:
a laptop, a smartphone, a desktop, a Virtual Reality (VR) device, a device supporting Augmented Reality (AR), and a device supporting Mixed Reality (MR); and
generating, by the rendering unit coupled to the processor, for each of the plurality of user devices the set of render textures based on the respective unique draw call set and the respective type of the user device.

11. A system for render streaming an environment to a plurality of user devices, wherein the system comprises:
the plurality of user devices, wherein each of the plurality of user devices is configured to send a connection establishment request to establish an active connection with a server; and
the server as claimed in claim 1.

12. A system for render streaming an environment to a plurality of user devices, wherein the system comprises:
the plurality of user devices, wherein each of the plurality of user devices is configured to send a connection establishment request to establish an active connection with a server; and
the server as claimed in claim 2.

13. A system for render streaming an environment to a plurality of user devices, wherein the system comprises:
the plurality of user devices, wherein each of the plurality of user devices is configured to send a connection establishment request to establish an active connection with a server; and
the server as claimed in claim 3.

14. A system for render streaming an environment to a plurality of user devices, wherein the system comprises:
the plurality of user devices, wherein each of the plurality of user devices is configured to send a connection establishment request to establish an active connection with a server; and
the server as claimed in claim 4.

15. A system for render streaming an environment to a plurality of user devices, wherein the system comprises:
the plurality of user devices, wherein each of the plurality of user devices is configured to send a connection establishment request to establish an active connection with a server; and
the server as claimed in claim 5.
